(19) United States
(12) Patent Application Publication
(10) Pub. No.: US 2018/0075312 A1
(43) Pub. Date: Mar. 15, 2018

(54) OBJECT RECOGNITION METHOD, PROGRAM, AND OPTICAL SYSTEM

(71) Applicant: KABUSHIKI KAISHA TOSHIBA, Minato-ku (JP)

(72) Inventors: Hiroshi OHNO, Yokohama (JP); Takeshi Morino, Yokohama (JP); Tomonao Takamatsu, Kawasaki (JP)

(73) Assignee: KABUSHIKI KAISHA TOSHIBA, Minato-ku (JP)

(21) Appl. No.: 15/450,159

(22) Filed: Mar. 6, 2017

(30) Foreign Application Priority Data
Sep. 13, 2016 (JP) 2016-178953

(51) Int. Cl. G06K 9/20; G06T 7/55; G06K 9/00

(52) U.S. Cl. CPC G06K 9/2018; G06K 9/00201; G06T 7/55; G06K 9/2036

(57) ABSTRACT

An optical system according to an embodiment includes: an irradiation device including a light source configured to emit light to an object; an imaging device including an imaging element, and configured to receive reflected light from the object, and obtain an image with respect to a first wavelength and an image with respect to a second wavelength that is different from the first wavelength; and a processing circuit configured to compare the image with respect to the first wavelength and the image with respect to the second wavelength to extract and separate a Fresnel reflection component and a scattering component included in the reflected light, and obtain at least one of a surface shape or a surface profile of the object based on the Fresnel reflection component and the scattering component.

### CROSS REFERENCE TO RELATED APPLICATIONS

This application is based upon and claims the benefit of priority from prior Japanese Patent Application No. 2016-178953 filed on Sep. 13, 2016 in Japan, the entire contents of which are incorporated herein by reference.

### FIELD

Embodiments described herein relate generally to object recognition methods, programs, and optical systems.

### BACKGROUND

An optical machine vision system takes an image of an object using an optical system, and detects the shape and the surface profile of the object based on the image. Such a system has an advantage as it may determine the shape in a contactless manner.

However, the information that can be extracted from the image includes degenerated data of the shape and the surface profile of the object. Therefore, when the shape data is extracted, the surface profile information acts as noise. On the contrary, when the surface profile data is extracted, the shape information acts as noise. Thus, in order to perform a highly accurate detection, the degradation problem needs to be solved.

### BRIEF DESCRIPTION OF THE DRAWINGS

FIG. 1 is a diagram showing an optical system according to a first embodiment.

FIG. 2 is a diagram for explaining bidirectional reflectance distribution function (BRDF).

FIG. 3 is a diagram showing a bidirectional reflectance distribution function (BRDF).

FIG. 4A is a diagram showing a processed image of a BRDF and FIG. 4B is a diagram showing a processed image of a reflectance R with respect to the wavelength of 450 nm, and FIG. 4C is a diagram showing a processed image of a BRDF and FIG. 4D is a diagram showing a processed image of a reflectance R with respect to the wavelength of 750 nm.

FIG. 5A is a diagram showing the spectrum of the high color-rendering LED, and FIG. 5B is a diagram showing the spectrum of a common LED.

FIG. 6 is a diagram showing an optical system used to carry out an object recognition method according to a third embodiment.

FIG. 7 is a diagram for explaining the object recognition method according to the third embodiment.

FIG. 8 is a flow chart showing the procedure of the object recognition method according to the third embodiment.

FIG. 9 is a diagram showing an optical system used to carry out an object recognition method according to a fourth embodiment.

### DETAILED DESCRIPTION

An optical system according to an embodiment includes: an irradiation device including a light source configured to emit light to an object; an imaging device including an imaging element, and configured to receive reflected light from the object, and obtain an image with respect to a first wavelength and an image with respect to a second wavelength that is different from the first wavelength; and a processing circuit configured to compare the image with respect to the first wavelength and the image with respect to the second wavelength to extract and separate a Fresnel reflection component and a scattering component included in the reflected light, and obtain at least one of a surface shape or a surface profile of the object based on the Fresnel reflection component and the scattering component.

Embodiments will now be described with reference to the accompanying drawings.

### First Embodiment

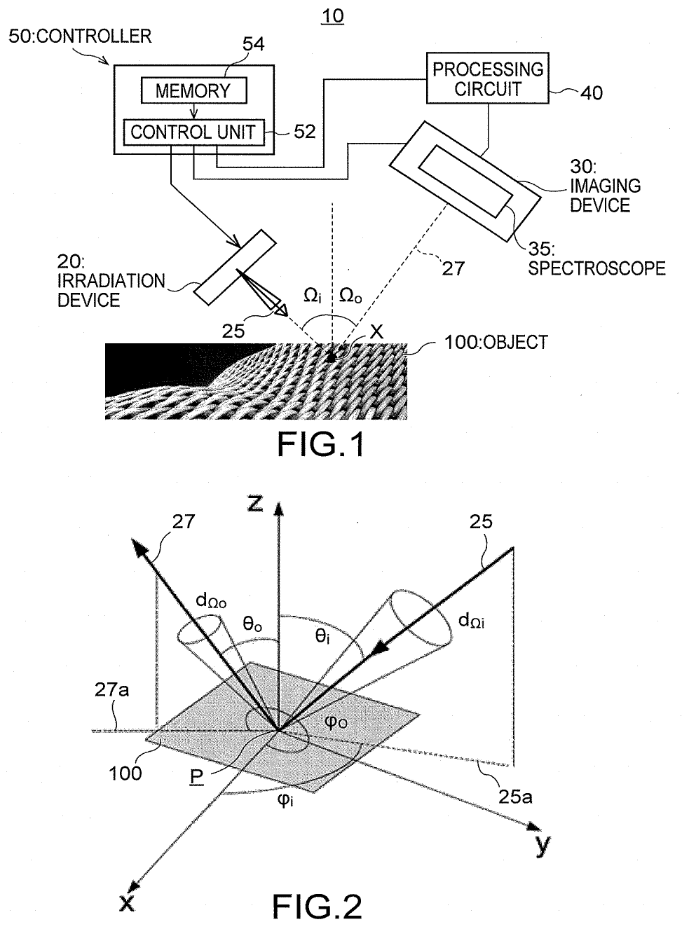

FIG. 1 shows an optical system according to a first embodiment. The optical system 10 includes an irradiation device 20 configured to emit light to an object 100, an imaging device 30 configured to take an image of light reflected from the object 100 and convert the image to an electrical signal, a processing circuit 40, and a controller 50.

The irradiation device 20 includes a light source capable of emitting light rays with at least two wavelengths. The light rays emitted from the irradiation device 20 are visible light rays in a wavelength range of about 450 nm to about 700 nm. The types of light, however, are not limited to the foregoing, and light with electromagnetic waves, from ultraviolet light to light with microwaves, may be used.

The imaging device 30 includes an imaging element capable of taking an image with respect to light rays having at least two wavelengths. An example of the imaging element is a camera. The two wavelengths of light rays that may be used to form an image are assumed to be λ₁ and λ₂, with λ₁ being smaller. In the first embodiment, the imaging device 30 includes a spectroscope 35 capable of separating light rays into two wavelength regions, a wavelength region Λ₁ including the wavelength λ₁, and a wavelength region Λ₂ including the wavelength λ₂. The spectroscope 35 may be disposed on a light path between the irradiation device 20 and the imaging device 30.

The processing circuit 40 processes electrical signals from the imaging device 30. The controller 50 includes a control unit 52 and a memory 54. The control unit 52 controls the irradiation device 20, the imaging device 30, and the processing circuit 40. The control unit 52 controls, for example, the irradiation device 20 with respect to the types of light rays emitted from the irradiation device 20 to the object 100, the directions of the light rays, and the irradiation timing, the imaging device 30 with respect to the imaging position (imaging angle), imaging timing, and timing for outputting the taken image, and the processing circuit 40 with respect to the image processing timing. The memory 54 stores the above control procedure. The control unit 52 controls the irradiation device 20, the imaging device 30, and the processing circuit 40 based on the control procedure stored in the memory 54.

The object 100 may be anything as long as it reflects the irradiation light. In the first embodiment, the object 100 is, for example, a fiber fabric.

The optical system 10 emits a light ray 25 to the object 100 by means of the irradiation device 20, and makes an image from a reflected light ray 27 reflected from the object 100 by means of the imaging device 30. If the fiber fabric 100 is, for example, a silk fabric, it has a macro structure called “fibroin,” and a fine structure with a diameter of several tens nanometers, called “microfibril,” included within the macro structure. Thus, the object 100 includes a structure that is smaller than the wavelength of visible light. Such a structure causes light to be divided into a component reflected on the surface of the object 100 and a component passing though the surface of the object 100 but is scattered and reflected by the internal structure. Generally, an object including an internal structure that is smaller than the wavelength of light causes light to be divided into a reflection component that is reflected by the surface and a scatter reflection component that is reflected and scattered by the internal structure.

The irradiation light is, for example, LED (light emitting diode) light that is substantially fully converted from excitation light by means of a fluorescent material. Such LED light generally has high color rendering properties.

The principles of the optical system according to the first embodiment will be described below.

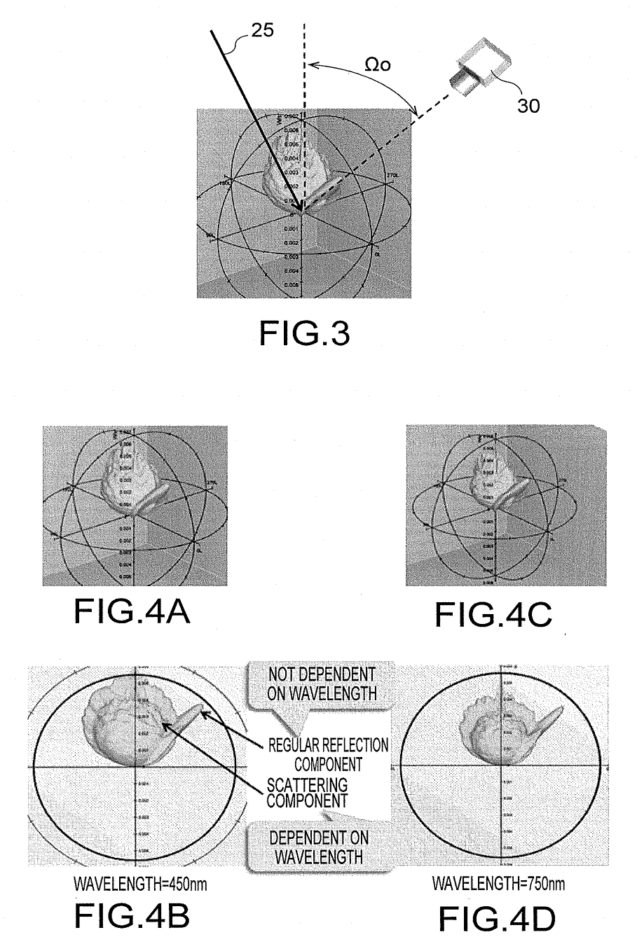

The reflection characteristics of the object 100 are generally expressed by a bidirectional reflectance distribution function (BRDF). As shown in FIGS. 2 and 3, the BRDF is expressed as the reflectance R per unit wavelength interval and per unit area with respect to the object 100. The reflectance R can be described by the following formula (1):

R=R(λ,x,Ωᵢ,Ωₒ) (1)

where λ is the wavelength of light, x is the position on the object surface, Ωᵢ is the incident angle of the irradiation light, and Ωₒ is the reflection angle.

The incident angle Ωᵢ and the reflection angle Ωₒ represent the solid angles of the incident light ray 25 and the reflected light ray 27, respectively, and can be expressed in a manner described below:

In a coordinate system xyz with the point of origin P located on the object 100 as shown in FIG. 2, the angle between the z-axis and the incident light ray 25 is denoted by θᵢ, and the angle between the z-axis and the reflected light ray 27 is denoted by θₒ. A projection component of the incident light ray 25 when it is projected on the xy plane is denoted by 25a, a projection component of the reflected light ray 27 when it is projected on the xy plane is denoted by 27a, an angle between the x-axis and the projection component 25a is denoted by φᵢ, and an angle between the x-axis and the projection component 27a is denoted by φₒ. The incident angle Ωᵢ can be expressed as (θᵢ, φᵢ), and the reflection angle Ωₒ can be expressed as (θₒ, φₒ).

The BRDF of the object 100 including an internal structure that is smaller than the wavelength λ can be expressed by the following formula (2), by adding a component of the Fresnel reflection on the surface of the object and a component of the reflection caused by the internal scattering:

R^{T}=R^{Fresnel}(λ,x,Ωᵢ,Ωₒ)+R^{Scatter}(λ,x,Ωᵢ,Ωₒ) (2)

where R^{Fresnel} denotes the component of the Fresnel reflection on the surface of the object, and R^{Scatter} denotes the component of the reflection caused by the internal scattering of the object.

The Fresnel reflection component of the BRDF for regions of the same material is determined by the refractive index of the material. The refractive index of a common material does not substantially change in the visible light region in many cases. Even a material with the refractive index that is dependent on the wavelength has a wavelength region in which the refractive index is constant. This wavelength region is set to be a detection wavelength region. With respect to the detection wavelength region, the formula (2) can be rewritten as the following formula (3).

R^{T}(λ,x,Ωᵢ,Ωₒ)=R^{Fresnel}(x,Ωᵢ,Ωₒ)+R^{Scatter}(λ,x,Ωᵢ,Ωₒ) (3)

The first term on the right side of the formula (3), the Fresnel reflection component R^{Fresnel}, is not dependent on the wavelength. On the other hand, the second term on the right side of the formula (3), the scattering component R^{Scatter}, is dependent on the wavelength. Therefore, with respect to the two wavelengths λ1 and λ2, the following two formulas (3a) and (3b) can be obtained from the formula (3):

R^{T}(λ₁,x,Ωᵢ,Ωₒ)=R^{(Fresnel)}(x,Ωᵢ,Ωₒ)+R^{(Scatter)}(λ,x,Ωᵢ,Ωₒ) (3a)

R^{T}(λ₂,x,Ωᵢ,Ωₒ)=R^{(Fresnel)}(x,Ωᵢ,Ωₒ)+R^{(Scatter)}(λ₂,x,Ωᵢ,Ωₒ) (3b)

Thus, the reflectance is expressed by the Fresnel reflection component R^{Fresnel} obtained from the Fresnel reflection occurring on the object surface, and the scattering component R^{Scatter}. The dependence of the Fresnel reflection component R^{Fresnel} on the wavelength is small. If the object includes a structure having a size smaller than the wavelength of the incident light, the scattering component R^{Scatter} is significantly dependent on the wavelength.

FIGS. 4A to 4D show the optical simulation results of the BRDF of a fiber fabric. FIGS. 4A and 4B show processed images of the BRDF and the reflectance R with respect to the wavelength 450 nm, and FIGS. 4C and 4D show processed images of the BRDF and the reflectance R with respect to the wavelength 750 nm. The processed image of the reflectance R may be obtained by the processing circuit 40 from the image taken by the imaging device 30. As can be understood from FIGS. 4A to 4D, there are a regular reflection component and a scattering component for the two wavelengths. The regular reflection component has a substantially constant value, and the scattering component increases in value as the wavelength decreases.

The scattering component is generated by “microfibril,” which is a nanostructure of the fiber fabric. The regular reflection component is the Fresnel reflection component generated by surface reflection on a macro structure called “fibroin” of the fiber fabric. The Fresnel reflection is dependent on the refractive index of the material. For many materials, the dependence of the refractive index on the wavelength is small in the visible light region. Therefore, the Fresnel reflection has small dependence on the wavelength, and substantially constant with respect to the wavelength.

In this embodiment, the wavelength region in which the Fresnel reflection of an object is constant is defined as a detection region Λ_{O}. The Fresnel reflection component and other components of any object can be extracted from the BRDF using the aforementioned method if the detection is performed in the detection region Λ_{O}. Extraction is Performed by the processing circuit 40.

The following formula (4) can be obtained from the difference between the formula (3a) and the formula (3b).

R^{(Scatter)}(λ₁,x,Ωᵢ,Ωₒ)=R^{(Scatter)}(λ₂,x,Ωᵢ,Ωₒ)+R^{(T)}(λ₁,x,Ωᵢ,Ωₒ)−R^{(T)}(λ₂,x,Ωᵢ,Ωₒ) (4)

As can be understood from the formula (4), only the scattering component can be extracted from an observable amount, R^{(T)}. This extraction is also performed by the processing circuit 40.

The Fresnel reflection component can also be extracted by substituting the formula (4) into the formula (3a). Thus, the Fresnel reflection component and the scattering component can be separated from each other. The separation is also performed by the processing circuit 40.

Assuming that a typical scale of the finest structure of the object is L in the formula (4), and L has the following relationship with the wavelength λ₂ of the light,

L<<λ₂ (5)

substantially no scattering occurs with respect to light having a wavelength λ₂. Therefore, the following formula holds:

R^{(Scatter)}(λ₂,x,Ωᵢ,Ωₒ)≅0 (6)

At this time, the following formula (7) can be obtained from the formula (4):

R^{(Scatter)}(λ₁,x,Ωᵢ,Ωₒ)=R^{(T)}(λ₁,x,Ωᵢ,Ωₒ)−R^{(T)}(λ₂,x,Ωᵢ,Ωₒ) (7)

Thus, the scattering component with respect to the wavelength λ₁ is completely determined. Therefore, by setting the wavelength λ₂ to be considerably large, the scattering component and the Fresnel reflection component with respect to the wavelength λ₁ can be completely determined.

As described above, the scattering component and the Fresnel reflection component can be obtained by processing, by the processing circuit 40, an image taken by the imaging device 30.

The Fresnel reflection component is generated by a reflection on an object surface, and thus has information on the surface shape of the object. Therefore, the shape of the object may be reconstructed from the Fresnel reflection component of the taken image. If the angle of light incident on the object is known, the reflection angle may be calculated from the Fresnel reflection component of the taken image. As a result, the normal direction on the object surface can be estimated, and thus the surface shape of the object can be reconstructed.

The scattering component is generated by a fine internal structure near the surface of the object, the structure having a smaller scale than the wavelength of light. Otherwise, the scattering component is not dependent on the wavelength, and the scattering component measured by the extraction method described above becomes substantially zero. Therefore, whether there is a fine internal structure in the object may be determined by the scattering component value. A typical scale L of a finest internal structure of the object has the following relationship with respect to the wavelength λ of light:

L<<λ (5a)

If the scattering component is extracted by the above method, data on the fine internal structure may be extracted by the processing circuit 40 due to the dependence of the scattering component on the wavelength, the irradiation angle, or the reflection angle.

### (Irradiation Light)

Next, irradiation light will be described. Assuming that the amount of irradiation light proportional to the spectrum (hereinafter also referred to the spectrum) is P(λ), the pixel value O of the image taken by the imaging device 30 may be expressed as follows:

O(λ,x,Ωᵢ,Ωₒ)=P(λ)R(λ·x,Ωᵢ,Ωₒ) (8)

If the spectrum P(λ) is known, the BRDF of the object may be expressed as:

$$\frac{O ( λ , x , {Ω}_{i} , {Ω}_{o} )}{P ( λ )} = R ( λ , x , {Ω}_{i} , {Ω}_{o} ) \qquad ( 9 )$$

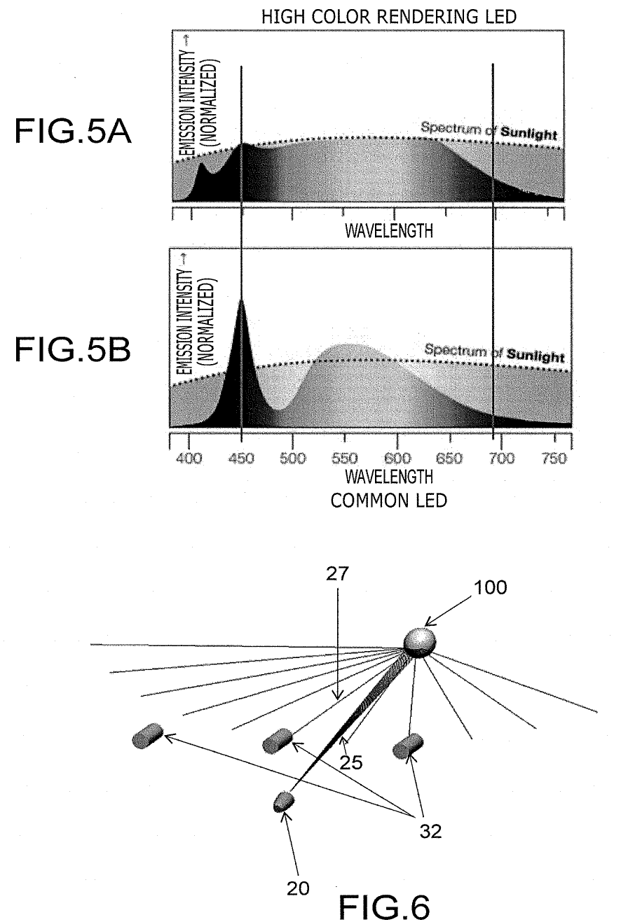

An LED spectrum generally includes an excitation light component and a conversion light component obtained from the conversion by a fluorescent material. FIG. 5B shows the spectrum of a common LED. The conversion efficiency of fluorescent materials used for LEDs is known to be easily affected by variations in temperature. Therefore, the ratio between the excitation light component and the conversion light component is easily affected by the temperature T of the LED. If the fluctuation of the spectrum caused by the temperature is defined by ΔP, the following formula may be obtained:

P(λ)=P̅(λ)+ΔP(λ) (10)

Therefore, the shape of the spectrum may be changed due to variations in temperature. Thus, the formula (9) may change as follows:

$$\frac{O ( λ , x , {Ω}_{i} , {Ω}_{o} )}{P ( λ )} = ( 1 + \frac{Δ P ( λ )}{\overline{P} ( λ )} ) ( {R}^{( F )} ( x , {Ω}_{i} , {Ω}_{o} ) + {R}^{( S )} ( λ , x , {Ω}_{i} , {Ω}_{o} ) ) \qquad ( 11 )$$

This means that an error may be caused by variations in temperature.

On the other hand, if the excitation light is entirely absorbed by a fluorescent material, the spectrum of the LED light only includes a conversion light component from the fluorescent material, like the high color-rendering LED spectrum shown in FIG. 5A. Such a spectrum is expressed as:

P(λ)=P̅(λ)+δ×P̅(λ)=(1+δ)P̅(λ) (12)

The value δ is not dependent on the wavelength. Therefore, the relative shape of the spectrum does not change. In this case, the formula (9) may change as follows:

$$\frac{O ( λ , x , {Ω}_{i} , {Ω}_{o} )}{P ( λ )} = ( 1 + δ ) ( {R}^{( F )} ( x , {Ω}_{i} , {Ω}_{o} ) + {R}^{( S )} ( λ , x , {Ω}_{i} , {Ω}_{o} ) ) \qquad ( 13 )$$

Thus, variations in temperature do not affect the shape of the spectrum.

As described above, the first embodiment is capable of obtaining a scattering component and a Fresnel reflection component of light reflected from an object, using light rays with two or more wavelengths. As a result, the shape or the surface profile of an object may be accurately detected.

### Second Embodiment

In the optical system 10 according to the first embodiment, the mirror reflection or the Fresnel reflection occurs on the surface of an object, and scattering occurs inside the object. However, depending on the type of the object, diffuse reflection occurs on the surface of the object. The optical system 10 according to the first embodiment may also be used for such an object. This will be described as a second embodiment. The optical system according to the second embodiment has the same structure as the optical system according to the first embodiment, but the incident direction of light emitted from the irradiation device 20 is changed.

When the diffuse reflection occurs on the surface of the object, the formulas (3a) and (3b) change as follows:

R^{T}(λ₁,x,Ωᵢ,Ωₒ)=R^{(Fresnel)}(x,Ωᵢ,Ωₒ)+R^{(Diffuse)}(x,Ωᵢ,Ωₒ)+R^{(Scatter)}(λ₁,x,Ωᵢ,Ωₒ) (14a)

R^{T}(λ₂,x,Ωᵢ,Ωₒ)=R^{(Fresnel)}(x,Ωᵢ,Ωₒ)+R^{(Diffuse)}(x,Ωᵢ,Ωₒ)+R^{(Scatter)}(λ₂,x,Ωᵢ,Ωₒ) (14b)

The difference between the formulas (14a) and (14b) is as follows:

R^{(Scatter)}(λ₁,x,Ωᵢ,Ωₒ)=R^{(Scatter)}(λ₂,x,Ωᵢ,Ωₒ)+R^{(T)}(λ₁,x,Ωᵢ,Ωₒ)−R^{(T)}(λ₂,x,Ωᵢ,Ωₒ) (15)

Therefore, like the first embodiment, only the scattering component may be extracted from R^{(T)}, which is a observable amount. For example, if the scattering component with respect to the wavelength λ is calculated, the following formula (16) can be obtained from the formula (14a):

R^{(Fresnel)}(x,Ωᵢ,Ω^{o})+R^{(Diffuse)}(x,Ωᵢ,Ωₒ)=R^{T}(λ,x,Ωᵢ,Ωₒ)−R^{(Scatter)}(λ,x,Ωᵢ,Ωₒ) (16)

Since the right side of the formula (16) is known, the left side of the formula (16) can be calculated.

However, the Fresnel reflection component R^{(Fresnel)} and the diffuse reflection component R^{(Scatter)} in the formula (16) are degenerated. In order to deal with this, the irradiation direction or the reflection direction of light is changed by controlling the irradiation device 20 by means of the controller 50, and an image after this change is detected by the imaging device 30. Thereafter, the BRDF is obtained by the processing circuit 40 based on the detected images, and the sum of the Fresnel component and the diffuse reflection component is calculated by the processing circuit 40 using the formula (16). The Fresnel reflection component R^{(Fresnel)} can be completely described if the refractive index is given. Thus, only the refractive index n is unknown. Therefore, using the Fresnel reflection formula with the refractive index n being an unknown parameter, the refractive index that may well match an actually measured value is estimated, and the degeneration of the formula (16) is solved.

Thus, the optical system according to the second embodiment can be applied to the case where not only the Fresnel reflection but also the diffuse reflection occurs on the surface of an object.

The second embodiment is capable of obtaining a scattering component and a Fresnel reflection component of reflected light from an object using light rays with two or more wavelengths, like the first embodiment. As a result, the shape or the surface profile of an object may be accurately detected.

### Third Embodiment

An object recognition method according to a third embodiment will be described with reference to FIGS. 6 to 8. FIG. 6 shows an optical system used to perform the object recognition method according to the third embodiment. The optical system is the optical system 10 according to the first embodiment, in which the irradiation device 20 emits one type of light, and the imaging device 30 includes a plurality of cameras (stereo cameras) 32.

Each camera 32 is capable of separating received light into light rays with at least two wavelengths. For example, the received light may be separated into R (red), G (green), and B (Blue) wavelength regions. The peak wavelength of each wavelength region is 450 nm, 550 nm, or 680 nm.

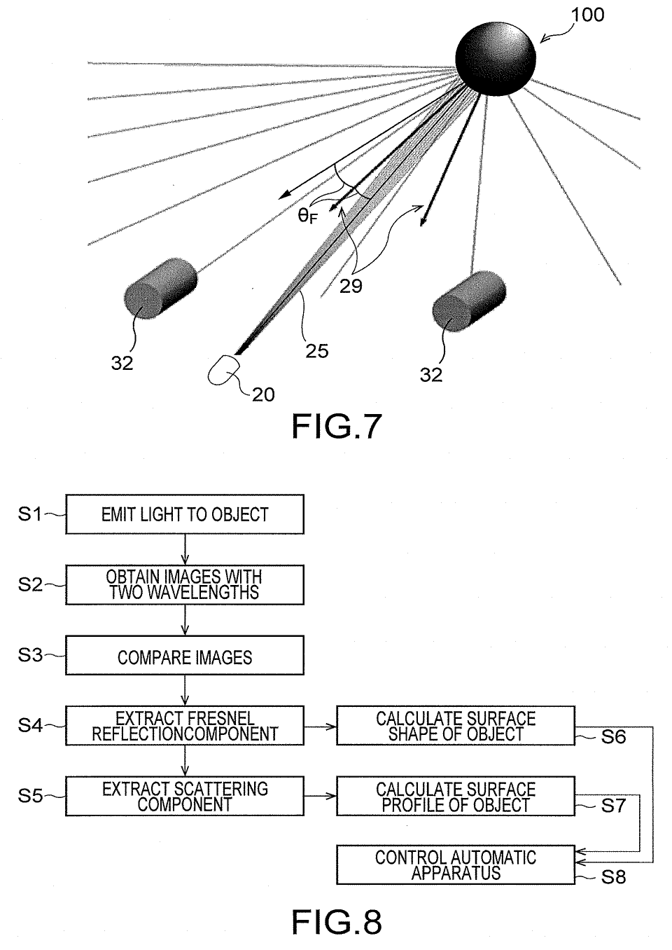

As shown in FIG. 7, light 25 is emitted from an irradiation device 20 to an object 100, and the cameras 32 simultaneously receive reflected light rays 27 and make images. The Fresnel reflection component is extracted from the images taken by the cameras 32 by means of the method described in the descriptions of the first embodiment. The extraction is performed by the processing circuit 40.

If the irradiation angle of the irradiation light is known, the normal directions 29 of the object 100 can be calculated by the processing circuit 40 since the Fresnel reflection angle is equal to the irradiation angle. Therefore, the normal direction of a point on the object 100 to which light is emitted can be calculated. The shape of the object 100 may be obtained by calculating the normal direction at each of predefined points on the surface of the object 100. The shape of the object 100 can be reconstructed in this manner. Since calculating the normal direction at each point on the object 100 is very complicated and needs a lot of time, the surface of the object 100 may be divided into small portions of a mesh, and a normal direction may be obtained for each portion.

When the Fresnel reflection component is calculated, the scattering component can be extracted by the processing circuit 40 using the method described in the descriptions of the first embodiment. When the scattering component is extracted, information on the nanostructure within the object 100 may be extracted. For example, whether the object 100 is a fiber fabric may be determined by comparing the extracted scattering component with the scattering component with respect to the fiber fabric. Thus, the material of the object 100 may be estimated. As a result, the hardness, the elasticity, the weight, the density, and so on of the object may be estimated.

The object recognition method according to the third embodiment will be described with reference to FIG. 8. FIG. 8 shows a procedure of a process of controlling an automatic apparatus (for example, robot) using the object recognition method according to the third embodiment.

First, the control unit 52 controls the irradiation device to emit light to the object 100 (step S1 in FIG. 8). Subsequently, the reflected light from the object 100 is detected by the imaging device 30 to obtain images with two wavelengths (step S2). The processing circuit 40 extracts the Fresnel reflection component comparing and processing the images with two wavelengths (steps S3 and S4).

The processing circuit 40 calculates the surface shape of the object based on the extracted Fresnel reflection component (step S6). The processing circuit 40 also extracts the scattering component based on the extracted Fresnel reflection component (step S5). The processing circuit 40 further extracts the surface profile of the object based on the extracted scattering component (step S7).

The automatic apparatus is controlled based on the surface shape or the surface profile of the object thus obtained. The above procedure is stored in the memory of the controller 50 shown in FIG. 1. The controller 50 may be a computer.

As described above, the shape and the surface profile of the object may be determined by the object recognition method according to the third embodiment. The object recognition method according to the third embodiment is useful for automatic apparatuses that grab things.

The third embodiment is capable of obtaining a scattering component and a Fresnel reflection component of reflected light from an object using light rays with two or more wavelengths, like the first embodiment. As a result, the shape or the surface profile of an object may be accurately detected.

### Fourth Embodiment

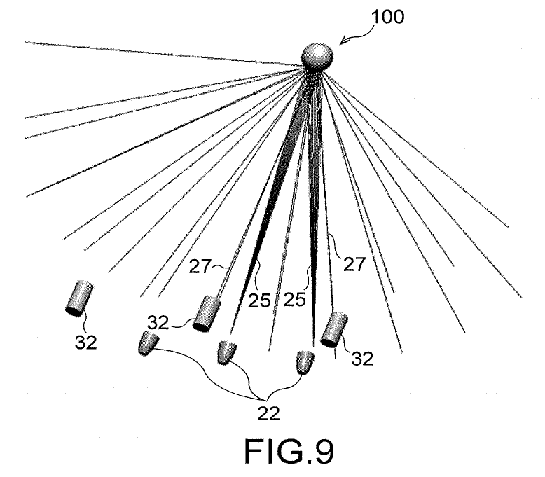

An object recognition method according to a fourth embodiment will be described with reference to FIG. 9. The object recognition method according to the fourth embodiment uses the optical system shown in FIG. 1, in which the imaging device 30 includes a plurality of cameras, and a plurality of light sources 22 each corresponding to a camera and each emitting light in a different direction is provided.

In the fourth embodiment, the light sources 22 emit light rays to the object 100 with time intervals. The Fresnel reflection component and the scattering component are extracted for the light ray emitted from each light source 22, using the method described in the descriptions of the first embodiment. As a result, the object shape may be obtained from the normal direction of the object 100, and the object surface profile may be reconstructed from the scattering component.

The fourth embodiment is capable of accurately detecting the shape or the surface profile of an object, like the first embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An optical system comprising:
an irradiation device including a light source configured to emit light to an object;
an imaging device including an imaging element, and configured to receive reflected light from the object, and obtain an image with respect to a first wavelength and an image with respect to a second wavelength that is different from the first wavelength; and
a processing circuit configured to compare the image with respect to the first wavelength and the image with respect to the second wavelength to extract and separate a Fresnel reflection component and a scattering component included in the reflected light, and obtain at least one of a surface shape or a surface profile of the object based on the Fresnel reflection component and the scattering component.

2. The system according to claim 1, wherein the object includes a fine structure therein, and the second wavelength is greater than a size of the fine structure.

3. The system according to claim 1, wherein the processing circuit extracts and separates the Fresnel reflection component and the scattering component by obtaining a difference between the image with respect to the first wavelength and the image with respect to the second wavelength.

4. The system according to claim 1, further comprising a spectroscope configured to separate the light from the light source into a light ray with the first wavelength and a light ray with the second wavelength,
wherein the spectroscope is disposed on a light path from the light source to the imaging element, or within the imaging element.

5. The system according to claim 1, wherein the light source includes a conversion unit configured to generate excitation light and convert the excitation light to conversion light having a wavelength region that is wider than a wavelength region of the excitation light.

6. The system according to claim 1, wherein:
the imaging device includes a plurality of imaging elements; and
the processing circuit is configured to obtain at least one of a surface shape or a surface profile of the object using images taken by the imaging elements.

7. The system according to claim 1, wherein the irradiation device includes a plurality of light sources disposed to positions having different incident angles with respect to the object.

8. The system according to claim 7, wherein:
the irradiation device emit light rays from the light sources to the object with time intervals; and
the processing circuit obtains at least one of a surface shape or a surface profile of the object using images with respect to the light rays from the light sources.

9. An object recognition method comprising:
emitting light from a light source to an object;
receiving reflected light from the object, and obtaining an image with respect to a first wavelength and an image with respect to a second wavelength that is different from the first wavelength;
comparing the image with respect to the first wavelength with the image with respect to the second wavelength for extracting and separating a Fresnel reflection component and a scattering component of the reflected light; and
obtaining at least one of a surface shape or a surface profile of the object based on the Fresnel reflection component and the scattering component.

10. The method according to claim 9, wherein the extracting and separating includes obtaining a difference between the image with respect to the first wavelength and the image with respect to the second wavelength.

11. The method according to claim 9, wherein:
the emitting includes emitting, with time intervals, light rays from a plurality of light sources disposed to positions having different incident angles to the object; and
the extracting and separating including extracting and separating the Fresnel reflection component and the scattering component from images with respect to the light rays from the light sources.

12. The method according to claim 9, wherein:
the obtaining of an image includes obtaining images of the object from a plurality of imaging elements; and
the extracting and separating includes extracting and separating the Fresnel reflection component and the scattering component of the reflected light using images from the imaging elements.

13. A program configured to cause a computer to carry out:
a process to emit light from a light source to an object;
a process to receive reflected light from the object, and obtain an image with respect to a first wavelength and an image with respect to a second wavelength that is different from the first wavelength;
a process to compare the image with respect to the first wavelength and the image with respect to the second wavelength to extract and separate a Fresnel reflection component and a scattering component of the reflected light; and
a process to obtain at least one of a surface shape or a surface profile of the object based on the Fresnel reflection component and the scattering component.
